(19) United States
(12) Patent Application Publication
(10) Pub. No.: US 2020/0074647 A1
(43) Pub. Date: Mar. 5, 2020

(54) SMART GLASSES AND METHOD OF SELECTIVELY TRACKING TARGET OF VISUAL COGNITION

(71) Applicant: Electronics and Telecommunications Research Institute, Daejeon (KR)

(72) Inventors: Jin Young MOON, Daejeon (KR); Yong Jin KWON, Daejeon (KR); HYUNG IL KIM, Daejeon (KR); Ki Min YUN, Daejeon (KR); Jong Youl PARK, Daejeon (KR); Sung Chan OH, Seoul (KR); Jeun Woo LEE, Gyeryong-si (KR)

(73) Assignee: Electronics and Telecommunications Research Institute, Daejeon (KR)

(21) Appl. No.: 16/541,639

(22) Filed: Aug. 15, 2019

(30) Foreign Application Priority Data
Aug. 30, 2018 (KR) 10-2018-0102676
Nov. 14, 2018 (KR) 10-2018-0139813

(51) Int. Cl. G06T 7/292; G06F 3/01; G06T 7/00; G06T 7/70; G08B 7/06

(52) U.S. Cl. CPC G06T 7/292; G06F 3/013; G06T 7/97; G06T 2200/24; G08B 7/06; G06T 2207/30196; G06T 7/70

(57) ABSTRACT

Smart glasses for selectively tracking a target of visual cognition according to the present invention include a first camera configured to capture a first input image that is a first-person view image of a user, a second camera configured to capture a second input image containing sight line information of the user, a display configured to output additional information corresponding to the first input image, a memory configured to store a program for selectively tracking a target of visual cognition on the basis of the first and second input images, and a processor configured to execute the program stored in the memory, wherein upon executing the program, the processor is configured to detect the target of visual cognition from the first input image and determine, from the second input image, whether the user is in an inattentive state with respect to the target of visual cognition.

### CROSS-REFERENCE TO RELATED APPLICATION

This application claims priority to and the benefit of Korean Patent Application No. 2018-0102676, filed on Aug. 30, 2018 and Korean Patent Application No. 2018-0139813, filed on Nov. 14, 2018, the disclosure of which is incorporated herein by reference in its entirety.

### BACKGROUND

### 1. Field of the Invention

The present invention relates to smart glasses and a method of selectively tracking a target of visual cognition by the smart glasses.

### 2. Discussion of Related Art

Conventional intelligent image analysis techniques which use intelligent observation through face recognition and abnormal behavior detection in moving images received from a surveillance camera are mainly used to quickly respond to abnormal situations associated with a risk of a target of observation in order to protect the socially underprivileged, such as the handicapped, children, the elderly, patients, and the like.

Meanwhile, most of the visual assistant technologies using smart glasses offer functions of displaying information for the visually impaired to walk or provide operators with information required at working sites. However, such technologies do not provide a method of selecting visual information regarding how and what information is provided from an image in which actions and motions occur and numerous persons and objects appear in general daily living spaces of ordinary people.

As described above, the conventional technologies only visually enumerate what has been intelligently analyzed such that a user feels inconvenienced due to excessive information. Therefore, there is a need for a technology regarding when and what target is to be emphasized to the user among a number of targets of visual cognition, such as persons, objects, actions, and motions, which are present in an input video, or a technology for selectively providing relevant information.

### SUMMARY OF THE INVENTION

Embodiments of the present invention provide smart glasses and a method of selectively tracking a target of visual cognition, which allow a user to detect a person or an object wearing smart glasses, analyze a first-person view image of the user input from the smart glasses at the time of visual cognition for detecting a motion or an action of the detected person or object, track a user's gaze, and selectively assist in a user's visual cognition function when it is determined on the basis of the analysis result and the gaze tracking result that a target of visual cognition requiring a user's attention does not attract the user's attention.

However, technical objects to be attained by the embodiments are not limited to the above described objects and there may be other technical objects.

In one general aspect, smart glasses are provided for selectively tracking a target of visual cognition, the smart glasses including a first camera configured to capture a first input image that is a first-person view image of a user, a second camera configured to capture a second input image containing sight line information of the user, a display configured to output additional information corresponding to the first input image, a memory configured to store a program for selectively tracking a target of visual cognition on the basis of the first and second input images, and a processor configured to execute the program stored in the memory. In this case, upon executing the program, the processor may detect the target of visual cognition from the first input image and determine, from the second input image, whether the user is in an inattentive state with respect to the target of visual cognition.

The processor may determine the inattentive state on the basis of the sight line information when the user's gaze is not directed to the detected target of visual cognition for a predetermined period of time or more.

The processor may track the detected target of visual cognition during the inattentive state and output additional information of the currently tracked target of visual cognition to the display.

The processor may detect one or more of a person, an object, an action, and a motion as detection targets from the first input image and store the detected targets in the memory.

The processor may detect a user's gaze position in the second input image by tracking the user's gaze from the second input image, recognize a target of attention among the detection targets on the basis of the detected gaze position, generate the recognized target of attention into a user's attention history, and store the user's attention history in the memory.

The processor may update the target of visual cognition automatically or via a manual input by the user.

The processor may generate a group of candidate targets of visual cognition from the detection targets from the first input image on the basis of the user's attention history and automatically update the target of object cognition to the group of candidate targets of visual cognition.

The processor may generate the group of candidate targets of visual cognition such that the number of IDs of persons, types of objects, and types of actions and motions included in the user's attention history for a predetermined period of time corresponds to a predetermined number.

In another general aspect, there is provided a method of selectively tracking a target of visual cognition by smart glasses, the method including receiving a first input image that is a first-person view image of a user; detecting a target of visual cognition from the first input image; receiving a second input image containing sight line information of the user; determining, from the second input image, whether the user is in an inattentive state with respect to the target of visual cognition; and tracking the detected target of visual cognition during the inattentive state.

The determining of whether the user is in an inattentive state with respect to the target of visual cognition may include determining the inattentive state on the basis of the sight line information when the user's gaze is not directed to the detected target of visual cognition for a predetermined period of time or more.

The method may further include outputting additional information of the currently tracked target of visual cognition to a display.

The method may further include detecting and storing one or more of a person, an object, an action, and a motion as detection targets from the first input image.

The method may further include tracking a user's gaze from the second input image, detecting a user's gaze position in the second input image as a result of tracking, recognizing a target of attention among the detection targets on the basis of the detected gaze position, and generating the recognized target of attention into a user's attention history and storing the user's attention history.

The method may further include generating a group of candidate targets of visual cognition from the detection targets from the first input image on the basis of the user's attention history and automatically updating the target of object cognition to the group of candidate targets of visual cognition.

The generating of the group of candidate targets of visual cognition may include generating the group of candidate targets of visual cognition such that the number of IDs of persons, types of objects and types of actions and motions included in the user's attention history for a predetermined period of time corresponds to a predetermined number.

The target of visual cognition may be manually set by the user and be detected from the first input image.

In still another general aspect, there is provided smart glasses for selectively tracking a target of visual cognition, the smart glasses including a first camera configured to capture a first input image that is a first-person view image of a user, a second camera configured to capture a second input image containing sight line information of the user, a display configured to output additional information corresponding to the first input image, a memory configured to store a program for selectively tracking a target of visual cognition on the basis of the first and second input images, and a processor configured to execute the program stored in the memory. In this case, upon executing the program, the processor may detect detection targets from the first input image and store the detection targets in the memory, detect a user's gaze position in the second input image to recognize a target of attention among the detection targets, and set the detection target corresponding to the recognized target of attention to be a target of visual cognition to be tracked.

The processor may generate the recognized target of attention into a user's attention history, generate a group of candidate targets of visual cognition from the detection targets from the first input image on the basis of the user's attention history, and automatically update the target of object cognition to the group of candidate targets of visual cognition.

The processor may generate the group of candidate targets of visual cognition such that the number of IDs of persons, types of objects and types of actions and motions included in the user's attention history for a predetermined period of time corresponds to a predetermined number.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating smart glasses according to one embodiment of the present invention;

FIG. 2 is a flowchart illustrating a method of selectively tracking a target of visual cognition according to one embodiment of the present invention;

FIG. 3 is a flowchart illustrating an operation of tracking a target of visual cognition in an inattentive state of a user;

FIG. 4 is a flowchart illustrating an operation of detecting a target of visual cognition from a first input image;

FIG. 5 is a flowchart illustrating an operation of generating a user's attention history from a second input image;

FIG. 6 is a flowchart illustrating a method of setting a target of visual cognition; and

FIG. 7A and FIG. 7B are diagram illustrating examples of a user interface provided for smart glasses.

### DETAILED DESCRIPTION OF EXEMPLARY EMBODIMENTS

The present invention will be described more fully hereinafter with reference to the accompanying drawings which show exemplary embodiments of the invention. However, the present invention may be embodied in many different forms and is not to be construed as being limited to the embodiments set forth herein. Also, irrelevant details have been omitted from the drawings for increased clarity and conciseness.

Throughout the detailed description, unless explicitly described to the contrary, the word “comprise” and variations such as “comprises” or “comprising,” should be understood to imply the inclusion of stated elements but not the exclusion of any other elements.

The present invention relates to smart glasses 100 and a method of selectively tracking a target of visual cognition of the smart glasses.

According to one embodiment of the present invention, a first-person view image that is identical to an image viewed by a user may be input from the smart glasses 100, intelligent analysis, such as human recognition, object detection, action detection, or the like, may be performed on the input image, and when a predetermined important target of visual cognition is detected on the basis of the intelligent analysis, the target of visual cognition may be emphasized and represented on a display 130 of the smart glasses 100.

Accordingly, the present invention may be used to help visual cognitive function of the handicapped or the elderly with dementia who need assistance in visual cognitive function or may be used in training for strengthening cognitive function, and the present invention may assist in visual cognitive function so that a driver or an operator, who is likely to have an accident when a level of attention is lowered, does not miss an important target of visual cognition.

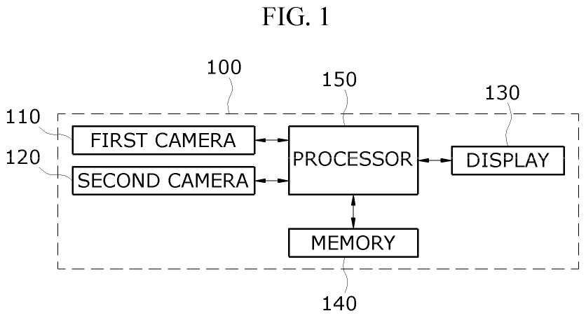

Hereinafter, the smart glasses 100 for selectively tracking a target of visual cognition according to one embodiment of the present invention will be described with reference to FIG. 1.

FIG. 1 is a block diagram illustrating the smart glasses 100 according to one embodiment of the present invention.

The smart glasses 100 according to one embodiment of the present invention include a first camera 110, a second camera 120, a display 130, a memory 140, and a processor 150.

The first camera 110 captures a first input image which is a first-person view image of a user. The first camera 110 may be implemented as, for example, a mono camera or a stereo camera and may further include a depth camera in some cases. These cameras may be formed by one or a plurality of combinations of cameras and photograph a view in a forward direction of a user's gaze.

The second camera 120 captures a second input image including sight line information of the user. That is, the second camera 120 captures a user's pupil image for tracking the user's gaze. For example, the second camera 120 may track the user's gaze by detecting a movement of the user's iris and generate gaze tracking information by checking eye blinking.

The display 130 outputs additional information that corresponds to the first input image. The display 130 may output an interface screen of the smart glasses 100 through an augmented reality (AR) technique or output an image by adding the additional information to an image currently viewed by the user.

A program for selectively tracking a target of visual cognition on the basis of the first and second input images is stored in the memory 140. Here, the memory 140 collectively refers to a non-volatile storage device that retains stored information even without supplying power and a volatile storage device.

For example, the memory 140 may include a NAND flash memory, such as a compact flash (CF) card, a secure digital (SD) card, a memory stick, a solid-state drive (SSD), or a micro SD card, a magnetic computer storage device such as a hard disk drive (HDD), an optical disc drive such as a compact disc read only memory (CD-ROM) or a digital video disc ROM (DVD-ROM), and the like.

The processor 150 executes the program stored in the memory 140, detects the target of visual cognition from the first input image, and determines, on the basis of the second input image, whether the user is inattentive to the target of visual cognition.

For reference, each component illustrated in FIG. 1 according to the embodiment of the present invention may be realized in the form of a software component or a hardware component, such as a field programmable gate array (FPGA) or an application specific integrated circuit (ASIC), and may perform predetermined roles.

However, the “components” are not limited to software or hardware components, and each of the components may be configured to reside on an addressable storage medium and be configured to be executed by one or more processors.

Thus, a component unit may include, by way of example, a component such as a software component, an object-oriented software component, a class component, and a task component, a process, a function, an attribute, a procedure, a subroutine, a segment of a program code, a driver, firmware, a microcode, circuitry, data, a database, a data structure, a table, arrays, and parameters.

The components and functionality provided by the components may be combined into fewer components or further separated into additional components.

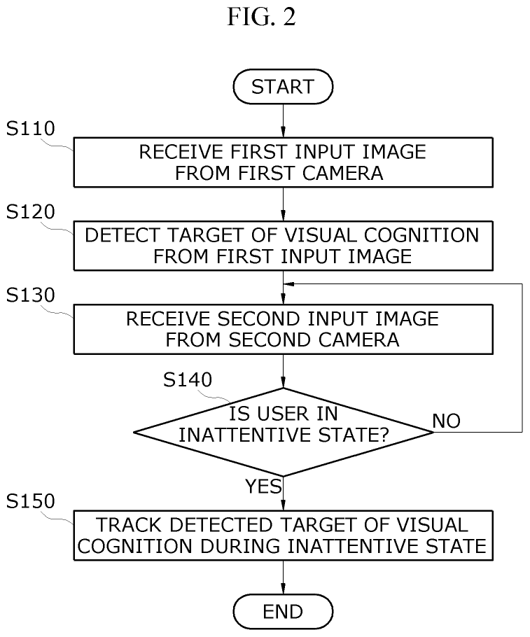

Hereinafter, a method of selectively tracking a target of visual cognition by the smart glasses 100 according to one embodiment of the present invention will be described in detail with reference to FIGS. 2 to 6.

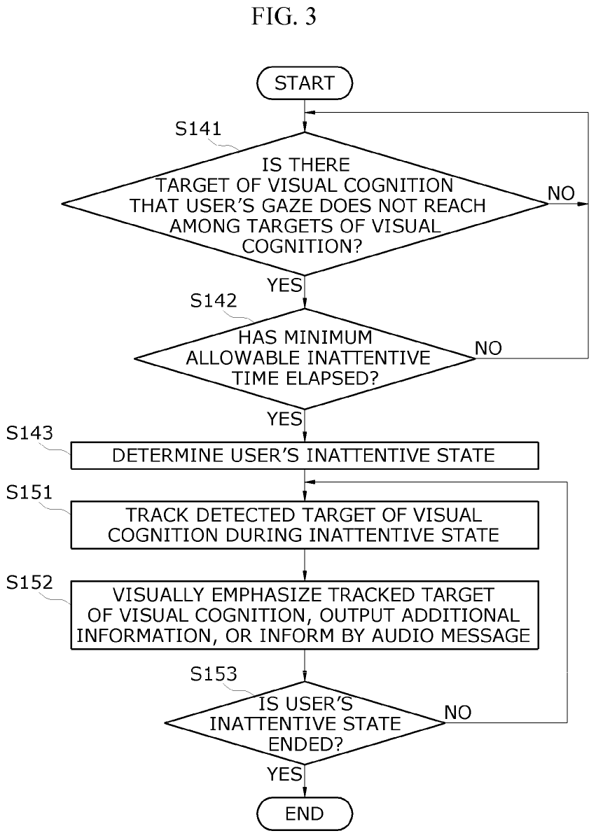

FIG. 2 is a flowchart illustrating a method of selectively tracking a target of visual cognition according to one embodiment of the present invention. FIG. 3 is a flowchart illustrating an operation of tracking a target of visual cognition in an inattentive state of a user.

In the method of selectively tracking a target of visual cognition according to one embodiment of the present invention, a first input image that is a first-person view image of the user is received from a first camera 110 (S110), and a target of visual cognition is detected from the first input image (S120). In this case, the target of visual cognition may be one or more of a person, an object, an action, and a motion, and setting and updating of the target of visual cognition will be described below.

Then, a second input image containing user's gaze information is received from a second camera 120 (S130), and whether the user is inattentive to the target of visual cognition is determined from the second input image (S140). Then, when it is determined that the user is in an inattentive state, the detected target of visual cognition is tracked during the inattentive state (S150). In this case, the operations of receiving the first input image and the second input image may be performed concurrently or sequentially.

Specifically, referring to FIG. 3, whether a target of visual cognition that the user's gaze does not reach is present among targets of visual cognition is primarily determined as a result of analysis of the second input image (S141).

When it is determined that there is a target of visual cognition that the user's gaze does not reach, whether the user's gaze does not reach the target of visual cognition for a predetermined time period or more that is a user's minimum allowable inattentive period is secondarily determined (S142).

When the secondary determination indicates that the user's gaze does not reach the target of visual cognition for the predetermined time period or more, the user's inattentive state is determined (S143).

The detected target of visual cognition is tracked during the inattentive state (S151), and additionally, the target of visual cognition, to which the user is not paying attention, is visually emphasized through AR or additional information regarding the target is output to the display 130 or informed by an audio message (S152).

The operation of tracking may be continuously performed until the user pays attention to the corresponding target of visual cognition, that is, until it is determined as a result of analysis of the second input image that the user's gaze position is directed to the corresponding target of visual cognition (S153).

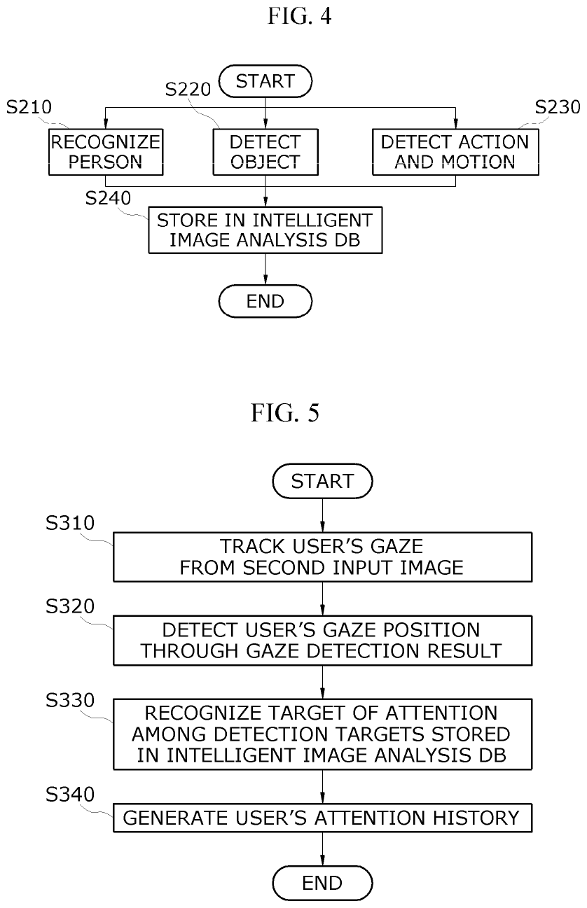

Meanwhile, according to one embodiment of the present invention, a target of visual cognition may be set or updated in advance in order to track the target of visual cognition, which will be described hereinafter with reference to FIGS. 4 to 6.

FIG. 4 is a flowchart illustrating an operation of detecting a target of visual cognition from the first input image.

In one embodiment of the present invention, a person and an object are detected as detection targets to be visually recognized in a first input image or actions and motions of the person and object are individually detected (S210 to S230).

In addition, a detection result is stored in an intelligent image analysis database (DB) in the memory 140 (S240). That is, one or more of a person, an object, an action, and a motion are detected from the first input image and stored in the intelligent image analysis DB.

FIG. 5 is a flowchart illustrating an operation of generating a user's attention history from the second input image.

In one embodiment of the present invention, the user's gaze is tracked from the second input image (S310), and the user's gaze position is detected in the second input image through a result of tracking the user's gaze (S320).

Then, a target of attention is recognized among the detection targets stored in the intelligent image analysis DB on the basis of the detected gaze position (S330), and a user's attention history, which indicates a target to which the user's attention is paid, is generated on the basis of the recognized target of attention and is stored (S340).

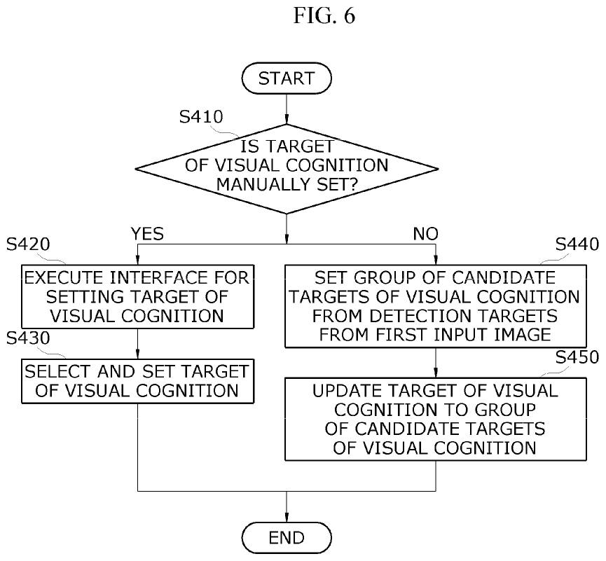

FIG. 6 is a flowchart illustrating a method of setting a target of visual cognition.

In one embodiment of the present invention, the target of visual cognition may be manually set or automatically updated by the processor 150. It is apparent that the method of manually or automatically setting the target of visual cognition may be performed independently or applied in combination.

First, in the method of manually setting a target of visual cognition by a user, since manual setting of the target of visual cognition is selected by the user through an interface (S410), the interface for setting a target of visual cognition is executed (S420). In addition, when the user selects a target of visual cognition among a person, an object, an action, and a motion through the interface, the selected target is set as a target of visual cognition to be tracked from the first image (S430).

Then, in the method of automatically setting a target of visual cognition by the processor 150, a group of candidate targets of visual cognition is generated from the detection targets obtained from the first input image on the basis of the user's attention history stored through the method of analyzing a user's attention shown in FIG. 5 (S440). In this case, the processor 150 may generate the group of candidate targets of visual cognition such that the number of IDs of persons, types of objects and types of actions and motions included in the user's attention history for a predetermined period of time (e.g., a specific recent period of time) corresponds to the predetermined number.

Then, the processor 150 automatically updates the target of visual cognition to the group of candidate targets of visual cognition (S450).

When the first input image is captured through the first camera 110 of the smart glasses 100 after the target of visual cognition is set or updated, a target set to be the target of visual cognition is detected from detection targets contained in the captured first input image and a target of visual cognition, to which the user is inattentive, is tracked by analyzing the second input image.

Meanwhile, the operations S110 to S450 may be further divided into more operations or combined into fewer operations according to embodiments of the present invention. In addition, some of the operations may be omitted if necessary, and the order of the operations may be changed. Further, any omitted descriptions of components or operations described with reference to FIG. 1 may be applied to the embodiment of the method of selectively tracking a target of visual cognition described with FIGS. 2 to 6.

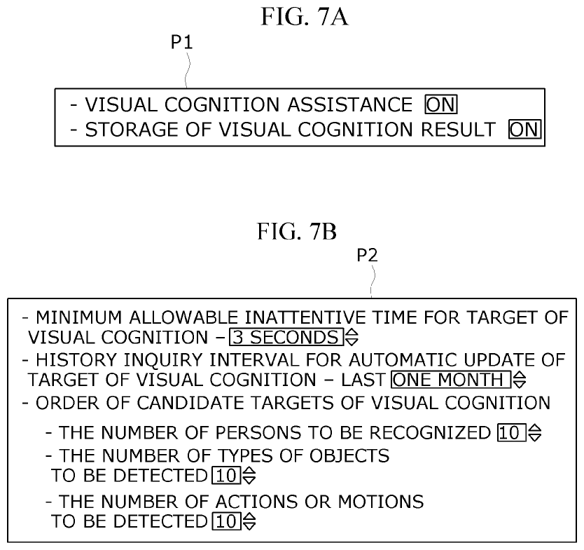

FIG. 7A and FIG. 7B are diagram illustrating examples of a user interface provided for the smart glasses 100.

First, as shown in FIG. 7A, according to one embodiment of the present invention, an interface P1 used to output whether a visual cognition assistance function is set and a storage state of a visual cognition result may be provided. In this case, when the visual cognition assistance function was set to be ON and storage of the visual cognition result was set to be ON, it indicates that the visual cognition result has been stored while the visual cognition assistance function is currently activated. In this state, a target of visual cognition is tracked and a notification message is provided when the user is in an inattentive state.

The notification message to be provided in the event of an inattentive state may be a notification message for urging the user to recognize the target of visual cognition and may be provided in various forms, such as a warning message output through a display, an audio message, vibration, and the like.

On the other hand, when the visual cognition assistance function was set to OFF and storage of the visual cognition result was set to ON, only the visual cognition result has been stored and visual emphasis on the target of visual cognition or the audio notification function for visual cognition assistance is deactivated.

In addition, in one embodiment of the present invention, as shown in FIG. 7B, an interface P2 used for setting a target of visual cognition may be provided. For example, in one embodiment of the present invention, an interface used for setting a minimum period of time for which an inattention to a target of visual cognition is allowed, a history inquiry interval for automatic update of a target of visual cognition, and the number of groups of candidate targets to be recognized.

According to one of the above-described embodiments, without simply enumerating analysis results of images captured by the smart glasses, targets of visual cognition are managed and in a case in which a pertinent target of visual cognition does not attract a user's attention, the target is selectively emphasized visually or auditorily or analysis information is provided so that warning, notification, and information can be provided for the target to which the user is inattentive among targets actually required to be visually recognized.

The embodiments of the present invention may be implemented in the form of a computer program stored in a medium executed by a computer or a recording medium that includes computer executable instructions. A computer-readable medium may be any usable medium that can be accessed by a computer and may include all volatile and nonvolatile media and detachable and non-detachable media. Also, the computer-readable medium may include all computer storage media and communication media. The computer storage medium includes all volatile and nonvolatile media and detachable and non-detachable media implemented by a certain method or technology for storing information such as computer-readable instructions, data structures, program modules, or other pieces of data. The communication medium typically includes computer-readable instructions, data structures, program modules, other pieces of data of a modulated data signal, such as a carrier wave, or other transmission mechanisms, and includes arbitrary information transmission media.

The method and system of the present invention have been described in connection with the specific embodiments of the invention, some or all of the components or operations thereof may be realized using a computer system that has general-use hardware architecture.

The foregoing description of the invention is for illustrative purposes, and a person having ordinary skilled in the art will appreciate that other specific modifications can be easily made without departing from the technical spirit or essential features of the invention. Therefore, the foregoing embodiments should be regarded as illustrative rather than limiting in all aspects. For example, each component described as being of a single type can be implemented in a distributed manner. Likewise, components described as being distributed can be implemented in a combined manner.

The scope of the present invention is not defined by the detailed description as set forth above but by the accompanying claims of the invention. It should also be understood that all changes or modifications derived from the definitions and scopes of the claims and their equivalents fall within the scope of the invention.

What is claimed is:

1. Smart glasses for selectively tracking a target of visual cognition, comprising:
a first camera configured to capture a first input image that is a first-person view image of a user;
a second camera configured to capture a second input image containing sight line information of the user;
a display configured to output additional information corresponding to the first input image;
a memory configured to store a program for selectively tracking a target of visual cognition on the basis of the first and second input images; and
a processor configured to execute the program stored in the memory,
wherein, upon executing the program, the processor is configured to detect the target of visual cognition from the first input image and determine, from the second input image, whether the user is in an inattentive state with respect to the target of visual cognition.

2. The smart glasses of claim 1, wherein the processor is configured to determine the inattentive state on the basis of the sight line information when the user's gaze is not directed to the detected target of visual cognition for a predetermined period of time or more.

3. The smart glasses of claim 2, wherein the processor is configured to track the detected target of visual cognition during the inattentive state and output additional information of the currently tracked target of visual cognition to the display.

4. The smart glasses of claim 2, wherein, when the inattentive state is determined, the processor is configured to provide a notification message through one or more of the display, an audio message, and vibration to urge the user to recognize the target of visual cognition.

5. The smart glasses of claim 1, wherein the processor is configured to detect one or more of a person, an object, an action, and a motion as detection targets from the first input image and store the detected targets in the memory.

6. The smart glasses of claim 5, wherein the processor is configured to detect a user's gaze position in the second input image by tracking the user's gaze from the second input image, recognize a target of attention among the detection targets on the basis of the detected gaze position, generate the recognized target of attention into a user's attention history, and store the user's attention history in the memory.

7. The smart glasses of claim 6, wherein the processor is configured to update the target of visual cognition automatically or via a manual input by the user.

8. The smart glasses of claim 7, wherein the processor is configured to generate a group of candidate targets of visual cognition from the detection targets from the first input image on the basis of the user's attention history and automatically update the target of object cognition to the group of candidate targets of visual cognition.

9. the smart glasses of claim 8, wherein the processor is configured to generate the group of candidate targets of visual cognition such that the number of IDs of persons, types of objects, and types of actions and motions included in the user's attention history for a predetermined period of time corresponds to a predetermined number.

10. A method of selectively tracking a target of visual cognition by smart glasses, the method comprising:
receiving a first input image that is a first-person view image of a user;
detecting a target of visual cognition from the first input image;
receiving a second input image containing sight line information of the user;
determining, from the second input image, whether the user is in an inattentive state with respect to the target of visual cognition; and
tracking the detected target of visual cognition during the inattentive state.

11. The method of claim 10, wherein the determining of whether the user is in an inattentive state with respect to the target of visual cognition comprises determining the inattentive state on the basis of the sight line information when the user's gaze is not directed to the detected target of visual cognition for a predetermined period of time or more.

12. The method of claim 10, further comprising outputting additional information of the currently tracked target of visual cognition to a display.

13. The method of claim 10, further comprising detecting and storing one or more of a person, an object, an action, and a motion as detection targets from the first input image.

14. The method of claim 13, further comprising:
tracking a user's gaze from the second input image;
detecting a user's gaze position in the second input image as a result of tracking;
recognizing a target of attention among the detection targets on the basis of the detected gaze position; and
generating the recognized target of attention into a user's attention history and storing the user's attention history.

15. The method of claim 14, further comprising:
generating a group of candidate targets of visual cognition from the detection targets from the first input image on the basis of the user's attention history; and
automatically updating the target of object cognition to the group of candidate targets of visual cognition.

16. The method of claim 15, wherein the generating of the group of candidate targets of visual cognition comprises generating the group of candidate targets of visual cognition such that the number of IDs of persons, types of objects and types of actions and motions included in the user's attention history for a predetermined period of time corresponds to a predetermined number.

17. The method of claim 10, wherein the target of visual cognition is manually set by the user and is detected from the first input image.

18. Smart glasses for selectively tracking a target of visual cognition, comprising:
a first camera configured to capture a first input image that is a first-person view image of a user;
a second camera configured to capture a second input image containing sight line information of the user;
a display configured to output additional information corresponding to the first input image;
a memory configured to store a program for selectively tracking a target of visual cognition on the basis of the first and second input images; and
a processor configured to execute the program stored in the memory,
wherein upon executing the program, the processor is configured to detect detection targets from the first input image and store the detection targets in the memory, detect a user's gaze position in the second input image to recognize a target of attention among the detection targets, and set the detection target corresponding to the recognized target of attention to be a target of visual cognition to be tracked.

19. The smart glasses of claim 18, wherein the processor is configured to generate the recognized target of attention into a user's attention history, generate a group of candidate targets of visual cognition from the detection targets from the first input image on the basis of the user's attention history, and automatically update the target of object cognition to the group of candidate targets of visual cognition.

20. The smart glasses of claim 19, wherein the processor is configured to generate the group of candidate targets of visual cognition such that the number of IDs of persons, types of objects and types of actions and motions included in the user's attention history for a predetermined period of time corresponds to a predetermined number.
